(19) United States
(12) Patent Application Publication
(10) Pub. No.: US 2025/0330987 A1
(43) Pub. Date: Oct. 23, 2025

(54) USER EQUIPMENT TRIGGERED UPLINK TRANSMISSIONS

(71) Applicant: Lenovo (United States) Inc., Morrisville, NC (US)

(72) Inventors: Hyejung JUNG, Palatine, IL (US); Joachim Löhr, Wiesbaden (DE)

(21) Appl. No.: 19/244,700

(22) Filed: Jun. 20, 2025

(51) Int. Cl. H04W 72/21; H04L 5/00; H04W 72/115

(52) U.S. Cl. CPC H04W 72/21; H04L 5/0044; H04W 72/115

(57) ABSTRACT

Various aspects of the present disclosure relate to user equipment (UE) triggered uplink configured grants. For example, the UE may be configured with a uplink grant configuration, which indicates a set of physical uplink control channel (PUCCH) resources and a set of physical uplink shared channel (PUSCH) resources, where the set of PUCCH resources are used based on one or more conditions (e.g., the arrival of uplink data or status reporting) associated with triggering the use of an uplink configured grant. In response to the trigger, the UE may select a PUSCH resource, transmit an indication of the selected PUSCH resource via a PUCCH resource, and transmits an uplink communication (e.g., the uplink data or status report) via the selected PUSCH resource.

### TECHNICAL FIELD

The present disclosure relates to wireless communications, and more specifically to user equipment triggered uplink transmissions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, processors, and systems that perform UE triggered uplink transmissions, such as uplink data and status reporting. The methods, apparatuses, processors, and systems of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to receive a configuration that indicates a set of physical uplink control channel (PUCCH) resources and a set of physical uplink shared channel (PUSCH) resources, wherein the set of PUCCH resources is configured for use based at least in part on a condition, select a first subset of one or more PUSCH resources of the set of PUSCH resources based at least in part on the condition, transmit an indication of the selected first subset of one or more PUSCH resources in at least one PUCCH resource of the set of PUCCH resources, and transmit an uplink communication in the selected first subset of one or more PUSCH resources.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to receive a configuration that indicates a set of PUCCH resources and a set of PUSCH resources, wherein the set of PUCCH resources is configured for use based at least in part on a condition, select a first subset of one or more PUSCH resources of the set of PUSCH resources based at least in part on the condition, transmit an indication of the selected first subset of one or more PUSCH resources in at least one PUCCH resource of the set of PUCCH resources, and transmit an uplink communication in the selected first subset of one or more PUSCH resources.

A method performed or performable by the UE is described. The method may comprise receiving a configuration that indicates a set of PUCCH resources and a set of PUSCH resources, wherein the set of PUCCH resources is configured for use based at least in part on a condition, selecting a first subset of one or more PUSCH resources of the set of PUSCH resources based at least in part on the condition, transmitting an indication of the selected first subset of one or more PUSCH resources in at least one PUCCH resource of the set of PUCCH resources, and transmitting an uplink communication in the selected first subset of one or more PUSCH resources.

In some implementations of the UE, processor, and method described herein, the UE, processor, and method may further be configured to, capable of, performed, performable, or operable to receive a physical downlink control channel (PDCCH) transmission, wherein the PDCCH transmission is associated with a cell-ratio network temporary identifier (C-RNTI) or a UE-triggered configured grant (UCG)-RNTI.

In some implementations of the UE, processor, and method described herein, the received PDCCH transmission includes a dynamic uplink grant, wherein the received PDCCH transmission is associated with the C-RNTI, and wherein the C-RNTI is indicative of the transmitted uplink communication being successfully decoded.

In some implementations of the UE, processor, and method described herein, the received PDCCH transmission includes a dynamic uplink grant, wherein the received PDCCH transmission is associated with the UCG-RNTI, and wherein the UCG-RNTI is indicative of the transmitted uplink communication being unsuccessfully decoded.

In some implementations of the UE, processor, and method described herein, the PDCCH transmission indicates an activation of a second subset of one or more PUSCH resources of the set of PUSCH resources.

In some implementations of the UE, processor, and method described herein, the first subset of the one or more PUSCH resources is selected based at least in part on an absence of a PDCCH transmission in response to a previous uplink communication on at least one PUSCH resource of the set of PUSCH resources, and wherein the condition comprises the absence of the PDCCH transmission.

In some implementations of the UE, processor, and method described herein, the configuration is a UE-triggered configured grant (UCG).

In some implementations of the UE, processor, and method described herein, the condition comprises one or more of UE status reporting or UE assistance messages, and wherein the first subset of one or more PUSCH resources of the set of PUSCH resources is selected based at least in part on the one or more of the UE status reporting or the UE assistance messages.

In some implementations of the UE, processor, and method described herein, the UE, processor, and method may further be configured to, capable of, performed, performable, or operable to transmit an indication to deactivate one or more PUCCH resources of the set of PUCCH resources based at least in part on the condition, wherein the condition comprises an absence of uplink data available for a future uplink communication, one or more UE status reports, or one or more UE assistance messages.

In some implementations of the UE, processor, and method described herein, the UE, processor, and method may further be configured to, capable of, performed, performable, or operable to jointly transmit the uplink communication and the indication to deactivate the one or more PUCCH resources in the selected first subset of one or more PUSCH resources.

In some implementations of the UE, processor, and method described herein, the UE, processor, and method may further be configured to, capable of, performed, performable, or operable to transmit the indication to deactivate the one or more PUCCH resources in a second PUCCH resource different than the at least one PUCCH resource associated with the transmitted indication of the selected first subset of one or more PUSCH resources.

In some implementations of the UE, processor, and method described herein, a time gap between an ending symbol of the at least one PUCCH resource and a starting symbol of the selected first subset of one or more PUSCH resources satisfies a threshold value.

In some implementations of the UE, processor, and method described herein, a periodicity associated with the set of PUCCH resources is different than a periodicity associated with the set of PUSCH resources.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to transmit a configuration that indicates a set of PUCCH resources and a set of PUSCH resources, wherein the set of PUCCH resources is configured for use based at least in part on a condition, receive an indication of a selected first subset of one or more PUSCH resources of the set of PUSCH resources in at least one PUCCH resource of the set of PUCCH resources, attempt to decode an uplink communication in the first subset of the one or more PUSCH resources in response to receiving the indication, and transmit a dynamic uplink grant to a UE.

A method performed or performable by the network entity is described. The method may comprise transmitting a configuration that indicates a set of PUCCH resources and a set of PUSCH resources, wherein the set of PUCCH resources is configured for use based at least in part on a condition, receiving an indication of a selected first subset of one or more PUSCH resources of the set of PUSCH resources in at least one PUCCH resource of the set of PUCCH resources, attempting to decode an uplink communication in the first subset of the one or more PUSCH resources in response to receiving the indication, and transmitting a dynamic uplink grant to a UE.

In some implementations of the network entity and method described herein, the network entity and method may further be configured to, capable of, performed, performable, or operable to transmit an indication to activate a second subset of the one or more PUSCH resources of the set of PUSCH resources in response to successfully decoding the uplink communication.

In some implementations of the network entity and method described herein, the network entity and method may further be configured to, capable of, performed, performable, or operable to transmit a PDCCH transmission associated with a C-RNTI or a UCG-RNTI for the UE.

In some implementations of the network entity and method described herein, the PDCCH transmission includes the dynamic uplink grant and wherein the C-RNTI is indicative of the uplink communication being successfully decoded.

In some implementations of the network entity and method described herein, the PDCCH transmission includes the dynamic uplink grant and wherein the UCG-RNTI is indicative of the uplink communication being unsuccessfully decoded.

### BRIEF DESCRIPTION OF THE DRAWINGS

FIG. 1 illustrates an example of a wireless communications system in accordance with aspects of the present disclosure.

FIG. 2 illustrates an example of signaling between an NE and a UE in accordance with aspects of the present disclosure.

FIG. 3 illustrates an example of signaling between an NE and a UE in accordance with aspects of the present disclosure.

FIG. 4 illustrates an example of a UE triggered configured uplink grant in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communications system employing the 5G radio access technology may utilize configured uplink grants for various UE uplink communications, such as status reporting (e.g., buffer status reporting (BSR), delay status reporting (DSR) in a radio resource control (RRC) connected state), data transmissions (e.g., small data transmission (SDT) in an RRC inactive state, cell switching (e.g., random access channel (RACH)-less lower layer triggered mobility (LTM) cell switching), handover operations (e.g., RACH-less handovers), and so on.

The wireless communication system may also utilize configured grant uplink resources for communications supported by the 6G radio access technology, such as ultra-reliable and low-latency communication (URLLC) services, extended reality (XR) services, and so on. The use of configured grants may enable power saving for UEs (e.g., due to reduced PDCCH monitoring) and/or increases in capacity (e.g., via multiple transmission occasions).

For example, the UE may trigger a scheduling request (SR) upon the arrival of uplink data or before performing status reporting. After triggering the SR, the UE attempts to detect a downlink control information (DCI) format of one or more PDCCH monitoring occasions, where the DCI format carries an uplink grant for the transmission of the uplink data or status reporting. The NE (e.g., a gNB), in response to the SR, may allocate uplink resources for the configured grants to a UE for hybrid automatic repeat request (HARQ) transmissions/retransmissions. The NE, via Type 1 configured grants, employs RRC to directly configure an uplink grant, including a periodicity with a semi-static resource allocation. Via Type 2 configured grants, the RRC defines the periodicity of the configured grant, which is signaled or activated by PDCCH addressed to a CS-RNTI associated with a UE. Such signaling leads to inefficiency, as round-trip and scheduling delays in data transmission and/or status reporting are introduced.

Thus, while uplink configured grants (e.g., Type 1 and/or Type 2), as utilized in 5G, may benefit various vertical services in 6G, their utilization is controlled (e.g., initiated) by the network, and thus may not efficiently support unpredictable or aperiodic UE communications, such as communications that are not predictable or periodically transmitted by the UE.

The present disclosure introduces a UE triggered mechanism for using uplink configured grants for UE communications and status reporting (e.g., low-latency UE status reporting), such as uplink configured grants for communications associated with services or applications enabled by the 6G radio access technology.

For example, the UE may be configured with an uplink grant configuration, which indicates a set of PUCCH resources and a set of PUSCH resources, where the set of PUCCH resources are used based on one or more conditions (e.g., the arrival of uplink data or status reporting) associated with triggering the use of an uplink configured grant. In response to the trigger, the UE selects a PUSCH resource, transmits an indication of the selected PUSCH resource via a PUCCH resource, and transmits an uplink communication (e.g., the uplink data or status report) via the selected PUSCH resource.

Thus, the UE may control the use of an uplink configured grant to transmit uplink communications (e.g., uplink data, status reporting, and so on) in a dynamic and/or unpredictable manner. In doing so, the use of configured grants for various 6G services and applications may be employed by a UE when the need arises, and not only when the network predicts or facilitates such communications, among other benefits.

Aspects of the present disclosure are described in the context of a wireless communications system.

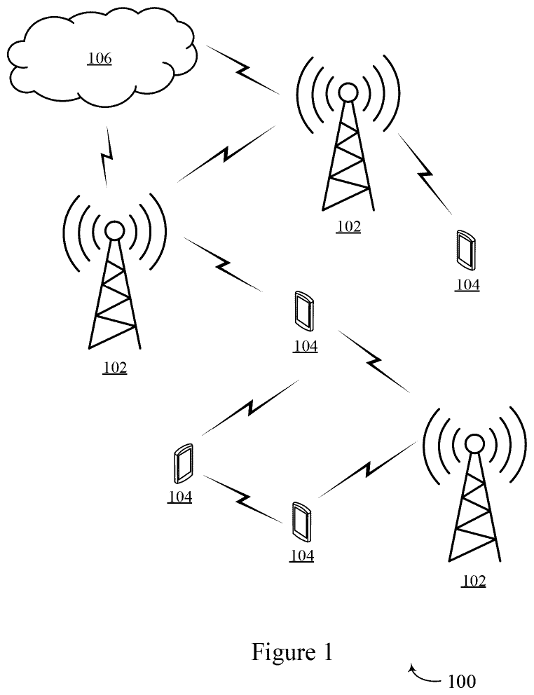

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies.

In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologics). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, one or more NE 102 may provision multiple sets of resources (e.g., time and frequency random access resources) to one or more UEs 104, where each set of resources of the multiple sets of resources is associated with selection criteria. By way of example, an NE 102 may determine selection criteria for each of one or more sets of resources of a plurality of sets of resources for random access, and transmit, to a UE 104, a configuration of the plurality of sets of resources for random access. The UE 104 may receive, from the NE 102, the configuration of the plurality of sets of resources for random access. In some examples, the UE 104 may select a set of resources of a plurality of sets of resources for random access based at least in part on criteria, and perform random access based at least in part on the selected set of resources.

As described herein, the wireless communications system 100 facilitates the control of uplink resources for configured grants by the UE 104, such as in response to one or more triggering conditions (e.g., the arrival of data at the UE 104, a request for status reporting, and so on). Example status reporting may include timing advance reports, positioning measurement gap activation/deactivation requests, a listen-before-talk (LBT) failure medium access control control element (MAC CE) that indicates a consistent LBT failure for all secondary cells (SCells) that triggered a consistent LBT failure, an enhanced beam failure recovery (BFR) MAC CE or a truncated enhanced BFR MAC CE, which includes beam failure recovery information for a beam failure detection-reference signal (BFD-RS) set of a serving cell, a MAC CE for BFR, which includes beam failure recovery information for an SCell, and so on.

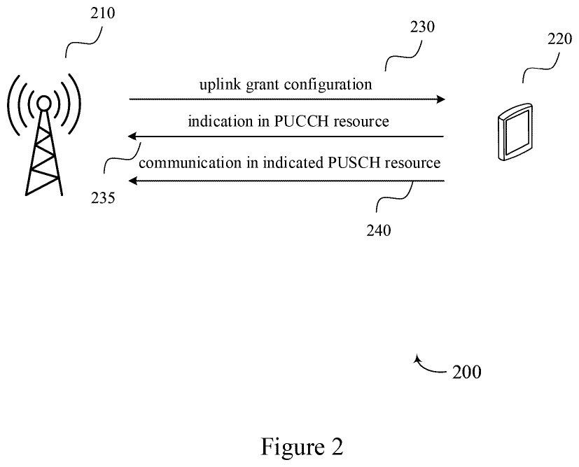

FIG. 2 illustrates an example of signaling 200 between an NE 210 and a UE 220 in accordance with aspects of the present disclosure. The UE 220 receives a uplink grant configuration 230 from the NE 210. The uplink grant configuration 230 may include configuration information (e.g., a UE-triggered configured uplink grant (UCG)) for one or more UL-SCH resources (e.g., PUSCH resources). In response to a condition (e.g., an arrival of uplink data and/or triggering of status reporting), the UE 220 sends an activation indication 235 for a PUSCH resource (e.g., in a PUCCH resource) and transmits a communication 240 (e.g., the uplink data, a status report, and/or a UE assistant information message) on the indicated and/or activated PUSCH resource.

In some examples, the configuration information for the UL-SCH resources may indicate any control channel or shared channel resources, and, thus, the uplink grant configuration 230 may indicate a first set or type of resources that are configured for use based on the condition (e.g., used to transmit the activation indication 235) and a second set or type of resources used for the uplink communication 240.

In some cases, when the UE 220 activates a UL-SCH resource in response to the condition (e.g., arrival of uplink data and/or triggering of status reporting, including UE assistance information messages) and indicates the activation of the UL-SCH resource to the NE 210, the NE 210 may determine, based on the activation indication 235, whether to monitor the UL-SCH resource or to repurpose the UL-SCH resource for other communications.

In response to the communication 240 (e.g., the uplink data and/or the status report) on the activated PUSCH resource, the UE 220 may attempt to detect a DCI format with a cyclic redundancy check (CRC) scrambled by a C-RNTI for a new transmission or a DCI format with CRC scrambled by a UCG-RNTI for a retransmission during a time window controlled by higher layer parameters. When the UE 220 detects the DCI format with the CRC scrambled with the C-RNTI, the UE 220 determines that the activation indication 235 is successfully detected and the uplink data and/or the status report sent on the activated PUSCH resource has been successfully decoded by the NE 210, and a received dynamic grant from the detected DCI format is used for a new data transmission. When the UE 220 detects the DCI format with the CRC scrambled with the UCG-RNTI, the UE 220 determines that the activation indication 235 was successfully detected but the uplink data and/or the status report sent on the activated PUSCH resource has not been successfully decoded by the NE 210, and a received dynamic grant from the detected DCI format is to be used for re-transmission of the uplink data and/or the status report.

In some cases, the DCI format with the CRC scrambled with the UCG-RNTI may indicate an activation of subsequently recurring PUSCH resources for the UE-triggered configured uplink grant or a deactivation of the UE-triggered configured uplink grant (e.g., a deactivation of activation indication resources and associated PUSCH resources). When the UE 220 receives a PDCCH addressed to the UCG-RNTI that indicates the activation or the deactivation, the UE 220 generates a UE-triggered configured uplink grant confirmation MAC CE and transmits the generated MAC CE.

When the UE 220 does not detect a DCI format addressed to the C-RNTI or the UCG-RNTI within the configured time window, the UE 220 determines that the activation indication 235 was not successfully detected by the NE 210. When the number of transmissions of the activation indication 235 is less than a configured or predefined maximum number of transmissions, the UE 220 may activate a new or different PUSCH resource of the UE-triggered configured uplink grant, send an activation indication for the newly activated PUSCH resource, and re-transmit the uplink data and/or the status report on the newly activated PUSCH resource. When the number of transmissions of the activation indication 235 meets or exceeds a maximum number of transmissions of the activation indication 235 and the UE 220 fails to detect a DCI format addressed to the C-RNTI or the UCG-RNTI in response to transmission of a latest activation indication, the UE 220 may initiate a random access procedure. In addition, the UE 220 may clear some or all configured uplink grants, some or all configured downlink assignments, semi-statically configured PUCCH resources and sounding reference signal (SRS) resources, semi-persistent PUSCH resources, and so on.

When the NE 210 receives or detects the activation indication 235, the NE 210 decodes a PUSCH on a PUSCH resource associated with the activation indication 235. After successful decoding of the PUSCH, the NE 210 sends a dynamic uplink grant addressed to a C-RNTI for a new transmission by the UE 220. When a decoding attempt of the PUSCH fails, the NE 210 sends a dynamic uplink grant addressed to a UCG-RNTI for a retransmission of the uplink data and/or the status report by the UE 220. When the NE 210 does not receive or detect the activation indication 235, the NE 210 determines the PUSCH resource as being deactivated and may perform downlink transmission and/or uplink reception on a resource overlapping with the deactivated PUSCH resource.

In some cases, a time window for detection of the DCI format may starts at a first symbol of an earliest control resource set (CORESET) foe which the UE 220 is configured to receive a PDCCH for a UE-specific search space set. This symbol may be at least one symbol after a last symbol of an activated PUSCH resource, where a symbol duration corresponds to an SCS for the UE-specific search space set.

In some cases, UCG configuration information for the one or more PUSCH resources may be specific to the UE 220 and transmitted via a dedicated RRC signaling. Further, the UCG configuration information may include information of one or more resources configured for transmission of the activation indication 235.

In some cases, the activation indication 235 is a physical random access channel (PRACH) preamble dedicated to the UE 220. The UE 220 may receive respective association information between one or more dedicated PRACH preambles and the one or more PUSCH resources and send the activation indication 235 by transmitting a dedicated PRACH preamble associated with the activated PUSCH resource. In some cases, the activation indication 235 is a PUCCH that includes a sequence. The UE 220 may receive respective association information between one or more PUCCH resources and the one or more PUSCH resources and send the activation indication 235 by transmitting a PUCCH sequence associated with the activated PUSCH resource.

In some cases, the UCG configuration may include multiple PUSCH configurations. Each PUSCH configuration may be associated with a different resource block (RB) allocation, a different modulation and coding scheme (MCS), and/or a different demodulation reference signal (DMRS) antenna port or ports. Each PUSCH configuration may be associated with a different type of uplink data, a different type of logical channel or channels, and/or a different type of status report or reports. For example, the activation indication 235 may include a PUCCH having a sequence, where multiple PUCCH sequences are configured and each PUCCH sequence is associated with a respective PUSCH configuration. As another example, the activation indication 235 may include PUCCH having a sequence multiplied by a modulated symbol, such as a binary phase shift keying (BPSK) symbol or a quadrature phase shift keying (QPSK) symbol, where a different modulation symbol is associated with a respective PUSCH configuration of the multiple PUSCH configurations.

In some cases, a configured minimum time gap between an ending symbol of a transmission occasion for the activation indication 235 (e.g., a PRACH occasion, a PUCCH occasion) and a starting symbol of the activated PUSCH resource is utilized to accommodate a propagation delay and/or a processing delay for the NE 210. The UE 220 may determine a configured PUSCH resource as being activated and perform an uplink transmission on the PUSCH resource when the configured PUSCH resource starts later than the minimum time gap after transmission of the activation indication 235.

In some examples, the uplink grant configuration 230 configures one or more active PUCCH resources and one or more inactive PUSCH resources, where each PUCCH resource is associated with at least one PUSCH resource. The uplink grant configuration 230 may include such association information. In some cases, the PUCCH resources and the PUSCH resources may periodically occur with same or different periodicities.

In some cases, such as when the UE 220 predicts no uplink data and no triggering of status reporting within a certain time window, the UE 220 may send an indication to deactivate some PUCCH resources (of a set of PUCCH resources), such as PUCCH resources that occur within the time window.

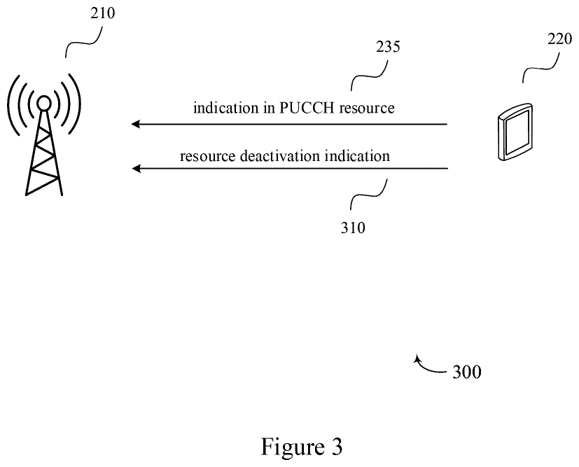

FIG. 3 illustrates an example of signaling 300 between an NE and a UE in accordance with aspects of the present disclosure. The UE 220 may select a time window from multiple (predefined) time window lengths or duration based on a predicted traffic or communication pattern. In some cases, different PUCCH sequences or different modulation symbols carried in PUCCH may correspond to different time window lengths.

In some cases, the UE 220 may activate a PUSCH resource, send an activation indication 235 of the PUSCH resource in an associated PUCCH resource, and send a deactivation indication 310 of upcoming PUCCH resources within a time window in the activated PUSCH resource. The UE 220 may send the deactivation indication 310 for the PUCCH resource along with other uplink data and/or status reports in the activated PUSCH resource.

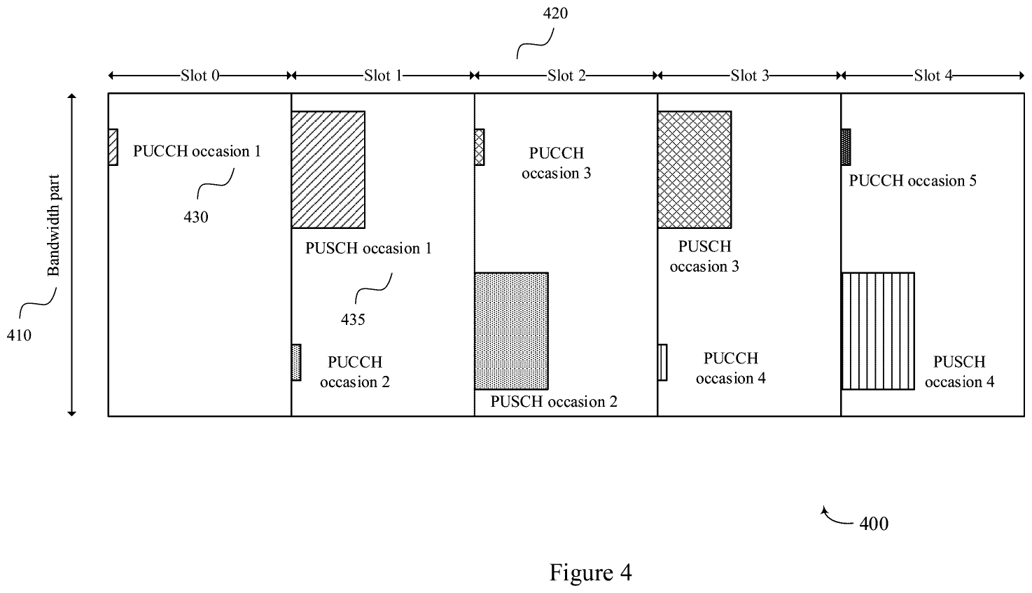

FIG. 4 illustrates an example of a UE triggered configured uplink grant 400 in accordance with aspects of the present disclosure. The configured uplink grant 400, for a bandwidth part (BWP) 410, includes periodic PUCCH resources 430 and PUSCH resources 435. A PUCCH occasion and a PUSCH occasion having a same index are associated. For example, when the UE 220 activates PUSCH occasion 2 and sends uplink data on the PUSCH occasion 2, the UE 220 sends an activation indication of the PUSCH occasion 2 on the PUCCH occasion 2. When the UE 220 expects no uplink transmission for mobile originated traffic for the next 20 slots 420, the UE 220 sends a deactivation indication of PUCCH occasions of the next 20 slots (e.g., staring from slot 3) along with the uplink data on the PUSCH occasion 2. In response to receiving the deactivation indication from the UE 220, the NE 210 does not monitor PUCCH occasions in the next 20 slots starting from slot 3.

Various aspects of the UE triggered uplink configured grant mechanism and associated processes may be implemented as follows.

In some examples, if a MAC entity of a UE has a C-RNTI and UCG-RNTI, the MAC entity shall for each PDCCH occasion and for each serving cell belonging to a timing advance group (TAG) that has a running timeAlignmentTimer and for each grant received for this PDCCH occasion:
1> if an uplink grant for this serving cell has been received on the PDCCH for the MAC entity's C-RNTI;
2> if the previous uplink grant delivered to the HARQ entity for the same HARQ process was either an uplink grant received for the MAC entity's UCG-RNTI or a UE-triggered configured uplink grant:
3> consider a new data indicator (NDI) to have been toggled for the corresponding HARQ process regardless of the value of the NDI.
2> if the identified HARQ process is configured for a UE-triggered configured
uplink grant:
3> start or restart the configuredGrantTimer for the corresponding HARQ process, if configured;
3> stop the cg-RetransmissionTimer for the corresponding HARQ process, if running.
2> deliver the uplink grant and the associated HARQ information to the HARQ entity.
1> else if an uplink grant for this PDCCH occasion has been received for this serving cell on the PDCCH for the MAC entity's UCG-RNTI:
2> consider the NDI for the corresponding HARQ process not to have been toggled
2> start or restart the configuredGrantTimer for the corresponding HARQ process, if configured;
2> stop the cg-Retransmission Timer for the corresponding HARQ process, if running;
2> deliver the uplink grant and the associated HARQ information to the HARQ entity;
2> if the NDI in the received HARQ information is 1:
3> activate UL-SCH resources of a UE-triggered configured uplink grant associated with the identified HARQ process
2> else if the NDI in the received HARQ information is 0:
3> deactivate a UE-triggered configured uplink grant associated with the identified HARQ process.

In some examples, a HARQ process ID associated with the first symbol of an activated UL-SCH resource of a UE-triggered configured uplink grant is derived from the following equation:

$$HARQ Process ID = [ floor ( CURRENT\_symbol / periodicity ) ] modulo nrofHARQ - Processes ,$$

where nrofHARQ-Processes is the number of HARQ processes configured for the UE-triggered configured uplink grant, and

$$CURRENT\_symbol = ( S FN \times numberOfSlotsPerFrame \times numberOfSymbolsPerSlot + slot number in the frame \times numberOfSymbolsPerSlot + symbol number in the slot ) ,$$

where memberOfSlotsPerFrame and memberOfSymbolsPerSlot above refer to the number of consecutive slots per frame and the number of consecutive symbols per slot, respectively.

In some examples, a network configures a HARQ process ID to be associated with UL-SCH resources of a UE-triggered configured uplink grant.

In some examples of a BSR procedure, a MAC entity of a UE shall:
1> if a Buffer Status reporting procedure determines that at least one BSR has been triggered and not cancelled:
2> if there is no dynamic uplink grant available and if the MAC entity is configured with a UE-triggered configured uplink grant(s), which is associated with a logical channel that triggered a Regular BSR;
3> activate an UL-SCH resource(s) of the UE-triggered configured uplink grant.
2> if UL-SCH resources are available for a new transmission and the UL-SCH resources can accommodate the BSR MAC CE plus its subheader as a result of logical channel prioritization:
3> instruct the Multiplexing and Assembly procedure to generate the BSR MAC CE(s);
3> start or restart periodicBSR-Timer except when all the generated BSRs are long or short Truncated or Extended long or short Truncated BSRs;
3> start or restart retxBSR-Timer;
3> if at least one UL-SCH resource of the available UL-SCH resources corresponds to the UE-triggered configured uplink grant;
4> instruct to a physical layer to transmit a PUCCH configured for an activation indication of the UE-triggered configured uplink grant.
2> if a Regular BSR has been triggered:
3> if there is no UL-SCH resource available for a new transmission; or
3> if the MAC entity is configured with network-controlled configured uplink grant(s) and the Regular BSR was triggered for a logical channel for which logicalChannelSR-Mask is set to false; or
3> if the UL-SCH resources available for a new transmission do not meet the LCP mapping restrictions configured for the logical channel that triggered the BSR:
4> trigger a scheduling request.

In some examples of a DSR procedure, if there is at least one DSR pending, the MAC entity shall:
1> if there is no dynamic uplink grant available and if the MAC entity is configured with a UE-triggered configured uplink grant(s), which is associated with a logical channel that triggered a DSR;
2> activate an UL-SCH resource(s) of the UE-triggered configured uplink grant.
1> if UL-SCH resources are available for a new transmission and the UL-SCH resources can accommodate the DSR MAC CE plus its subheader as a result of logical channel prioritization:
2> instruct the Multiplexing and Assembly procedure to generate the DSR MAC CE.
2> if at least one UL-SCH resource of the available UL-SCH resources corresponds to the UE-triggered configured uplink grant;
3> instruct to a physical layer to transmit a PUSCH configured for an activation indication of the UE-triggered configured uplink grant.
1> else if there is no pending SR already triggered by the DSR procedure for the same logical channel as of this DSR:
2> trigger a scheduling request.

In some examples, the RRC information element (IE) may implement a configured grant configuration and/or logical channel configuration, as described herein.

Example 1: UE-TriggeredConfiguredGrantConfig. The IE UE-TriggeredConfiguredGrantConfig configures inactive UL-SCH resources that can be activated by a UE and configures active uplink control channel resources to be used to indicate activation of a UL-SCH resource. The UE-TriggeredConfiguredGrantConfig IE:

-- ASN1START
-- TAG-UETRIGGEREDCONFIGUREDGRANTCONFIG-START

| | |
|---|---|
| UE-TriggeredConfiguredGrantConfig ::= | SEQUENCE { |
| periodicity | ENUMERATED { |
| | sym2, sym7, sym1x14, sym2x14, sym4x14, sym5x14, sym8x14, sym10x14, |

sym16x14, sym20x14,

sym32x14, sym40x14, sym64x14, sym80x14, sym128x14, sym160x14,

sym256x14, sym320x14, sym512x14,

```
  sym640x14, sym1024x14, sym1280x14, sym2560x14, sym5120x14,
  sym6, sym1x12, sym2x12, sym4x12, sym5x12, sym8x12, sym10x12,
```

sym16x12, sym20x12, sym32x12,

sym40x12, sym64x12, sym80x12, sym128x12, sym160x12, sym256x12,

sym320x12, sym512x12, sym640x12,

sym1280x12, sym2560x12

},

| | | |
|---|---|---|
| timeReferenceSFN | ENUMERATED {sfn512} | OPTIONAL -- |

Need S

| | | |
|---|---|---|
| autonomousTx | ENUMERATED {enabled} | OPTIONAL -- Cond LCH- |

BasedPrioritization

| configuredGrantTimer | INTEGER (1..64) | OPTIONAL, -- Need R |
|---|---|---|
| activationIndicationConfig | SEQUENCE { | |
| timeDomainOffset | INTEGER (0..5119), | |
| pucch-PowerControl | PUCCH-PowerControl | OPTIONAL, -- Need M |

| | |
|---|---|
| pucch-SpatialRelationInfo | PUCCH-SpatialRelationInfo OPTIONAL, -- Need M |
| initialCyclicShift | INTEGER(0..11), |
| nrofSymbols | INTEGER (1..2), |
| startingSymbolIndex | INTEGER(0..13) |
| startingPRB | PRB-Id, |
| intraSlotFrequencyHopping | ENUMERATED { enabled } |

OPTIONAL, -- Need R

| | | |
|---|---|---|
| secondHopPRB | PRB-Id | OPTIONAL, -- Need R |

}

| | |
|---|---|
| ueTriggered-ConfiguredUplinkGrant | SEQUENCE { |
| p0-PUSCH-Alpha | P0-PUSCH-AlphaSetId, |
| frequencyHopping | ENUMERATED {intraSlot, interSlot |

OPTIONAL, -- Need S

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| resource Allocation | ENUMERATED { resourceAllocationType0, resourceAllocationType1, |

dynamicSwitch },

| | | |
|---|---|---|
| rbg-Size | ENUMERATED {config2} | OPTIONAL, -- |

Need S

| | |
|---|---|
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| timeDomainOffset | INTEGER (0..5119), | |
|---|---|---|
| timeDomainAllocation | INTEGER (0.15), | |
| frequencyDomainAllocation | BIT STRING (SIZE(18)), | |
| antennaPort | INTEGER (0..31), | |
| precodingAndNumberOfLayers | INTEGER (0..63), | |
| srs-ResourceIndicator | INTEGER (0..15) | OPTIONAL, -- |

Need R

| | |
|---|---|
| mcsAndTBS | INTEGER (0..31), |
| frequencyHoppingOffset | INTEGER (1..maxNrofPhysicalResourceBlocks−1) |

OPTIONAL, -- Need R

| pathlossReferenceIndex | INTEGER (0..maxNrofPUSCH-PathlossReferenceRSs−1), | |
|---|---|---|
| startingFromRV0 | ENUMERATED {on, off} | OPTIONAL, -- |

Need R

| | |
|---|---|
| } | OPTIONAL, -- Need R |

}
-- TAG-UETRIGGEREDCONFIGUREDGRANTCONFIG-STOP
-- ASN1STOP

The field descriptions for the (IF-TriggeredConfiguredGrantConfig IE are shown in Table 1:

TABLE 1
UE-TriggeredConfiguredGrantConfig field descriptions

autonomousTx
If this field is present, the UE-Triggered Configured Grant configuration is configured with autonomous
transmission.
configuredGrantTimer
Indicates the initial value of the configured grant timer in multiples of periodicity. The value of the
extension configuredGrantTimer is 2 times the configured value.
periodicity
Periodicity for PUSCH resources and PUCCH resources for UL transmission with UE-triggered configured
uplink grant.
The following periodicities in symbols are supported depending on the configured subcarrier spacing:

| 15 kHz: | 2, 7, n*14, where n={1, 2, 4, 5, 8, 10, 16, 20, 32, 40, 64, 80, 128, 160, 320, 640} |
|---|---|
| 30 kHz: | 2, 7, n*14, where n={1, 2, 4, 5, 8, 10, 16, 20, 32, 40, 64, 80, 128, 160, 256, 320, |
| 640, 1280} | |
| 60 kHz with normal CP | 2, 7, n*14, where n={1, 2, 4, 5, 8, 10, 16, 20, 32, 40, 64, 80, 128, 160, 256, 320, |
| 512, 640, 1280, 2560} | |
| 60 kHz with ECP: | 2, 6, n*12, where n={1, 2, 4, 5, 8, 10, 16, 20, 32, 40, 64, 80, 128, 160, 256, 320, |
| 512, 640, 1280, 2560} | |
| 120 kHz: | 2, 7, n*14, where n={1, 2, 4, 5, 8, 10, 16, 20, 32, 40, 64, 80, 128, 160, 256, 320, |
| 512, 640, 1024, 1280, 2560, 5120} | |
| 480 and 960 kHz: | n*14, where n={1, 2, 4, 5, 8, 10, 16, 20, 32, 40, 64, 80, 128, 160, 256, 320, 512, |
| 640, 1024, 1280, 2560, 5120} | |

timeReferenceSFN
Indicates SFN used for determination of the offset of a resource in time domain. The UE uses the closest
SFN with the indicated number preceding the reception of the configured grant configuration. If the field
timeReferenceSFN is not present, the reference SFN is 0.
activationIndicationConfig
PUCCH configuration of UE-triggered configured uplink grant.
ueTriggered-ConfiguredUplinkGrant
PUSCH configuration of UE-triggered configured uplink grant.

The field descriptions for the activationIndicationConfig IE are shown in Table 2:

TABLE 2
activationIndicationConfig field descriptions

timeDomainOffset
Offset related to the reference SFN indicated by timeReferenceSFN for configured PUCCH resources.
pucch-PowerControl
Configures power control parameters PUCCH transmission.
pucch-SpatialRelationInfo
Configuration of the spatial relation between a reference signal and PUCCH. Reference signal can be
SSB/channel state information-reference signal (CSI-RS)/SRS.
initialCyclicShift
Index for an initial cyclic shift used for generating a PUCCH sequence.
nrofSymbols
The number of symbols configured for a PUCCH resource.
startingSymbolIndex
The starting symbol index within a slot for a PUCCH resource.
startingPRB
Index of first PRB of a PUCCH resource before frequency hopping.
intraSlotFrequencyHopping
Enabling intra-slot frequency hopping for configured PUCCH resources.
secondHopPRB
Index of first PRB after frequency hopping of PUCCH.

The field descriptions for the (IF-Triggered-ConfiguredUplinkGrant IE are shown in Table 3:

TABLE 3
UE-Triggered-ConfiguredUplinkGrant field descriptions

antennaPort
Indicates the antenna port(s) to be used for this PUSCH configuration, and the maximum bitwidth is 5.
cg-DMRS-Configuration
DMRS configuration for configured grant PUSCH.
frequencyDomainAllocation
Indicates the frequency domain resource allocation for configured grant PUSCH.
frequencyHopping
The value intraSlot enables ‘Intra-slot frequency hopping’ and the value interSlot enables ‘Inter-slot
frequency hopping’. If the field is absent, frequency hopping is not configured.
frequencyHoppingOffset
Frequency hopping offset used when frequency hopping is enabled for configured grant PUSCH.
mcs-Table
Indicates the MCS table the UE shall use for configured grant PUSCH without transform precoding. If the
field is absent the UE applies the value qam64.
mcs-TableTransformPrecoder
Indicates the MCS table the UE shall use for configured grant PUSCH with transform precoding. If the
field is absent the UE applies the value qam64.
mcsAndTBS
The modulation order, target code rate, and TB size of configured grant PUSCH.
nrofHARQ-Processes
The number of HARQ processes configured for configured grant PUSCH resources.
pathlossReferenceIndex
Indicates the reference signal index used as PUSCH pathloss reference.
p0-PUSCH-Alpha
Index of the P0-PUSCH-AlphaSet to be used for this configuration.
precodingAndNumberOfLayers
Indicates the precoding and number of layers for configured grant PUSCH.
rbg-Size
Selection between configuration 1 and configuration 2 for RBG size for configured grant PUSCH. The UE
does not apply this field if resourceAllocation is set to resourceAllocationType1. Otherwise, the UE applies
the value config1 when the field is absent. Note: rbg-Size is used when the transformPrecoder parameter is
disabled.
repK-RV
The redundancy version (RV) sequence to use. The network configures this field if repetitions are used,
i.e., if repK is set to n2, n4 or n8.
repK
Number of PUSCH repetitions K.
resourceAllocation
Configuration of resource allocation type 0 and resource allocation type 1. For Type 1 UL data
transmission without grant, resourceAllocation should be resourceAllocationType0 or
resource AllocationType1.
srs-ResourceIndicator
Indicates the SRS resource to be used for transmission in configured grant PUSCH resources.
startingFromRV0
This field is used to determine the initial transmission occasion of a transport block for a given RV
sequence.
timeDomainAllocation
Indicates a combination of start symbol and length and PUSCH mapping type.
timeDomainOffset
Offset related to the reference SFN indicated by timeReferenceSFN for configured grant PUSCH resources.
transformPrecoder
Enables or disables transform precoding. If the field is absent, the UE enables or disables transform
precoding for configured grant PUSCH in accordance with the field msg3-transformPrecoder in RACH-
ConfigCommon from rach-ConfigCommon included directly within BWP configuration.

Example 2: LogicalChannelConfig. The LogicalChannelConfig IE is used to configure the logical channel parameters. The LogicalChannelConfig IE is as follows:

-- ASN1START
-- TAG-LOGICALCHANNELCONFIG-START

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, kBps64, |
| | kBps128, kBps256, kBps512, kBps1024, kBps2048, kBps4096, |
| | kBps8192, kBps16384, kBps32768, kBps65536, infinity}, |
| bucketSizeDuration | ENUMERATED {ms5, ms10, ms20, ms50, ms100, ms150, ms30, |
| | ms500, ms1000, spare7, spare6, spare5, spare4, |
| | spare3, spare2, spare1}, |
| allowedServingCells | SEQUENCE (SIZE (1..maxNrofServingCells−1)) OF ServCellIndex |

OPTIONAL, -- Need R

| | |
|---|---|
| allowedSCS-List | SEQUENCE (SIZE (1..maxSCSs)) OF SubcarrierSpacing |

OPTIONAL, -- Need R

| maxPUSCH-Duration | ENUMERATED {ms0p02, ms0p04, ms0p0625, ms0p125, ms0p25, | |
|---|---|---|
| ms0p5, ms0p01, spare1} | OPTIONAL, -- Need R | |
| ueTriggeredConfiguredGrantAllowed ENUMERATED {true}, | | OPTIONAL, -- Need R |
| logical ChannelGroup | INTEGER (0..maxLCG-ID) | OPTIONAL, - |

- Need R

| | |
|---|---|
| bitRateQueryProhibitTimer | ENUMERATED {s0, sodot4, s0dot8, sldot6, s3, s6, s12, s30} |

OPTIONAL, -- Need R

| allowedCG-List | SEQUENCE (SIZE (0.. maxNrofConfiguredGrantConfigMAC-1-r16)) OF | |
|---|---|---|
| ConfiguredGrantConfigIndexMAC | OPTIONAL, -- Need S | |
| allowedPHY-Priority Index | ENUMERATED {p0, p1} | OPTIONAL - |

- Need S
} OPTIONAL, -- Cond UL
}
-- TAG-LOGICALCHANNELCONFIG-STOP
-- ASN1STOP

The field descriptions for the LogicalChannelConfig field IE are shown in Table 4:

TABLE 4
LogicalChannelConfig field descriptions

allowedCG-List
This restriction applies only when the UL grant is a configured grant. If present, UL MAC SDUs from this
logical channel can only be mapped to the indicated configured grant configuration. If the size of the
sequence is zero, then UL MAC SDUs from this logical channel cannot be mapped to any configured grant
configurations. If the field is not present, UL MAC SDUs from this logical channel can be mapped to any
configured grant configurations. If the field ueTriggeredConfiguredGrantAllowed is present, only those
UE-triggered configured grant configuration indicated in this sequence are allowed for use by this logical
channel; otherwise, this sequence shall not include any UE-triggered configured grant configuration.
allowedPHY-PriorityIndex
This restriction applies only when the UL grant is a dynamic grant. If the field is present and the dynamic
grant has a PHY-priority index, UL MAC SDUs from this logical channel can only be mapped to the
dynamic grants indicating PHY-priority index equal to the values configured by this field. If the field is
present and the dynamic grant does not have a PHY-priority index, UL MAC SDUs from this logical
channel can only be mapped to this dynamic grant if the value of the field is p0. If the field is not present,
UL MAC SDUs from this logical channel can be mapped to any dynamic grants.
allowedSCS-List
If present, UL MAC SDUs from this logical channel can only be mapped to the indicated numerology.
Otherwise, UL MAC SDUs from this logical channel can be mapped to any configured numerology.
Corresponds to ‘allowedSCS-List’ as specified in TS 38.321.
Only the following values are applicable depending on the used frequency:
FR1: 15, 30, or 60 kHz
FR2-1/FR2-NTN: 60 or 120 kHz
FR2-2: 120, 480, or 960 kHz
allowedServingCells
If present, UL MAC SDUs from this logical channel can only be mapped to the serving cells indicated in
this list. Otherwise, UL MAC SDUs from this logical channel can be mapped to any configured serving
cell of this cell group.
bitRateMultiplier
Bit rate multiplier for recommended bit rate MAC CE. Value x40 indicates bit rate multiplier 40, value x70
indicates bit rate multiplier 70 and so on.
bitRateQueryProhibitTimer
The timer is used for bit rate recommendation query, in seconds. Value s0 means 0 s, sodot4 means 0.4 s
and so on.
bucketSizeDuration
Value in ms. ms5 corresponds to 5 ms, value ms10 corresponds to 10 ms, and so on.
channelAccessPriority
Indicates the Channel Access Priority Class (CAPC), to be used on uplink transmissions for operation with
shared spectrum channel access in frequency range 1 (FR1). The network configures this field only for
signalling radio bearer 2 (SRB2) and data radio bearers (DRBs).
ueTriggeredConfiguredGrantAllowed
If present, or if the capability lcp-Restriction is not supported, UL MAC SDUs from this logical channel
can be transmitted on a UE-triggered configured grant. Otherwise, UL MAC SDUs from this logical
channel cannot be transmitted on a UE-triggered configured grant.
logicalChannelGroup
ID of the logical channel group, which the logical channel belongs to.
maxPUSCH-Duration
If present, UL MAC SDUs from this logical channel can only be transmitted using uplink grants that result
in a PUSCH duration shorter than or equal to the duration indicated by this field. Otherwise, UL MAC
SDUs from this logical channel can be transmitted using an uplink grant resulting in any PUSCH duration.
The PUSCH duration is calculated based on the same length of all symbols, and the shortest length applies
if the symbol lengths are different.
priority
Logical channel priority.
prioritisedBitRate
Value in kiloBytes/s. Value kBps0 corresponds to 0 kiloBytes/s, value kBps8 corresponds to 8 kiloBytes/s,
value kBps16 corresponds to 16 kiloBytes/s, and so on. For SRBs, the value can only be set to infinity.

Thus, in various examples, the present disclosure enables a UE (e.g., the UE 104 and/or 220) to trigger an uplink configured grant based on various conditions, in order to facilitate the transmission of uplink data (e.g., data, status reports, and so on) in an aperiodic, unexpected, unpredicted, or dynamic manner, among other benefits.

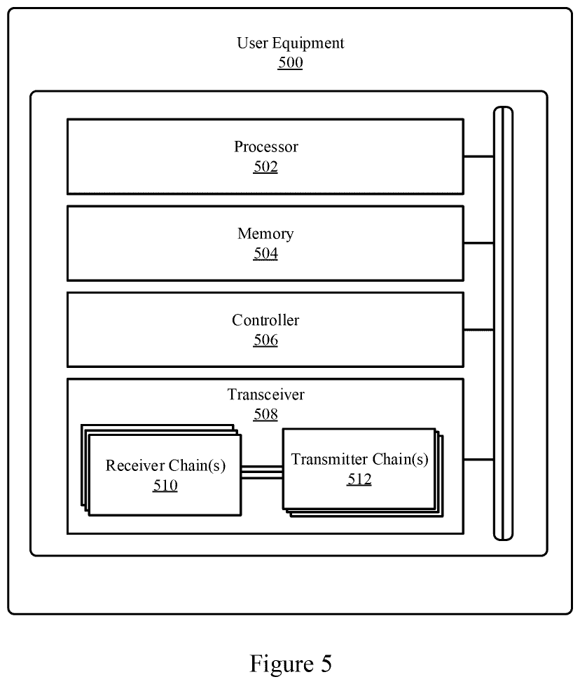

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for receiving a configuration that indicates a set of PUCCH resources and a set of PUSCH resources, wherein the set of PUCCH resources is configured for use based at least in part on a condition, selecting a first subset of one or more PUSCH resources of the set of PUSCH resources based at least in part on the condition, transmitting an indication of the selected first subset of one or more PUSCH resources in at least one PUCCH resource of the set of PUCCH resources, and transmitting an uplink communication in the selected first subset of one or more PUSCH resources.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

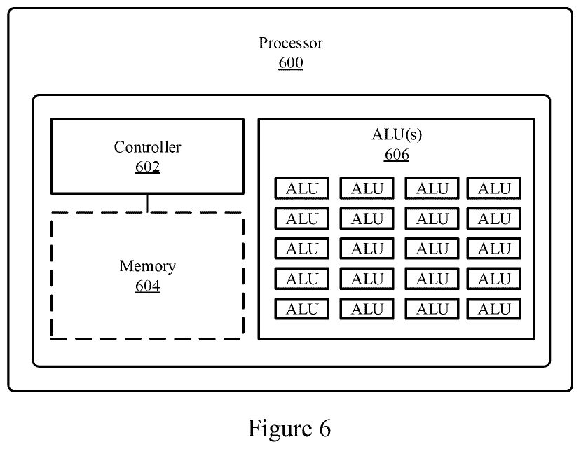

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. For example, the processor 600 may be configured to support a means for receiving a configuration that indicates a set of PUCCH resources and a set of PUSCH resources, wherein the set of PUCCH resources is configured for use based at least in part on a condition, selecting a first subset of one or more PUSCH resources of the set of PUSCH resources based at least in part on the condition, transmitting an indication of the selected first subset of one or more PUSCH resources in at least one PUCCH resource of the set of PUCCH resources, and transmitting an uplink communication in the selected first subset of one or more PUSCH resources.

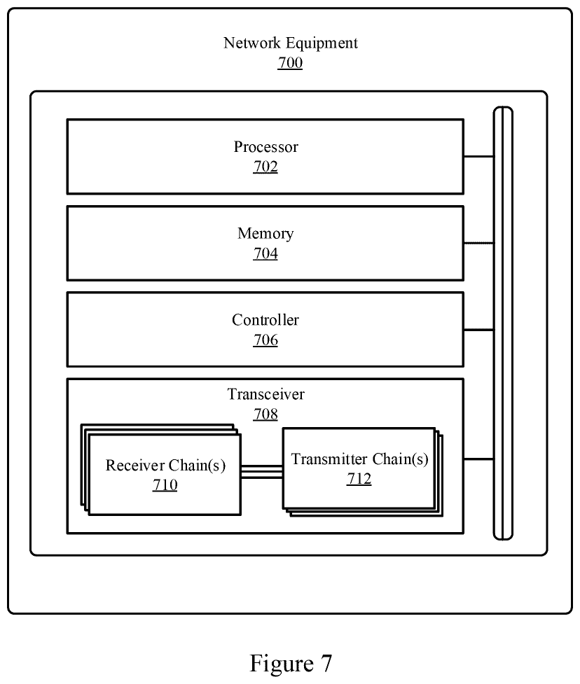

FIG. 7 illustrates an example of a NE 700 in accordance with aspects of the present disclosure. The NE 700 may include a processor 702, a memory 704, a controller 706, and a transceiver 708. The processor 702, the memory 504, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704).

For example, the processor 702 may support wireless communication at the NE 700 in accordance with examples as disclosed herein. The NE 700 may be configured to support a means for transmitting a configuration that indicates a set of PUCCH resources and a set of PUSCH resources, wherein the set of PUCCH resources is configured for use based at least in part on a condition, receiving an indication of a selected first subset of one or more PUSCH resources in at least one PUCCH resource of the set of PUCCH resources, attempting to decode an uplink communication in the first subset of the one or more PUSCH resources in response to receiving the indication, and transmitting a dynamic uplink grant to a UE.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

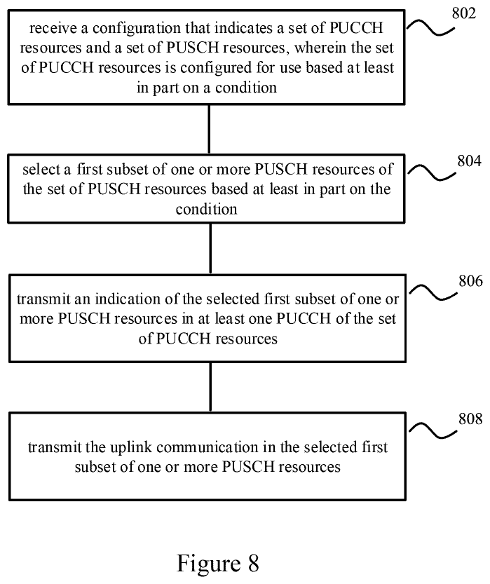

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving a configuration that indicates a set of PUCCH resources and a set of PUSCH resources, wherein the set of PUCCH resources is configured for use based at least in part on a condition. The operations of 802 may be performed in accordance with examples as described herein. In some implementations, aspects of the operations of 802 may be performed by a UE as described with reference to FIG. 5.

At 804, the method may include selecting a first subset of one or more PUSCH resources of the set of PUSCH resources based at least in part on the condition. The operations of 804 may be performed in accordance with examples as described herein. In some implementations, aspects of the operations of 804 may be performed by a UE as described with reference to FIG. 5.

At 806, the method may include transmitting an indication of the selected first subset of one or more PUSCH resources in at least one PUCCH resource of the set of PUCCH resources. The operations of 806 may be performed in accordance with examples as described herein. In some implementations, aspects of the operations of 806 may be performed by a UE as described with reference to FIG. 5.

At 808, the method may include transmitting an uplink communication in the selected first subset of one or more PUSCH resources. The operations of 808 may be performed in accordance with examples as described herein. In some implementations, aspects of the operations of 808 may be performed by a UE as described with reference to FIG. 5.

It should be noted that the method described herein describes a possible implementation, and that the operations and the steps may be rearranged or otherwise modified and that other implementations are possible.

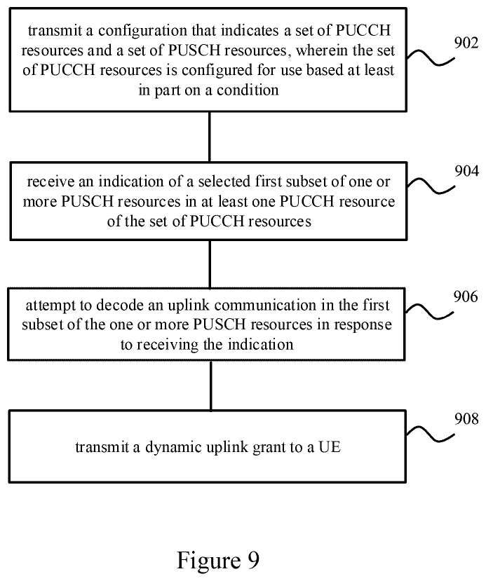

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include transmitting a configuration that indicates a set of PUCCH resources and a set of PUSCH resources, wherein the set of PUCCH resources is configured for use based at least in part on a condition. The operations of 902 may be performed in accordance with examples as described herein. In some implementations, aspects of the operations of 902 may be performed by an NE as described with reference to FIG. 7.

At 904, the method may include receiving an indication of a selected first subset of one or more PUSCH resources in at least one PUCCH resource of the set of PUCCH resources. The operations of 904 may be performed in accordance with examples as described herein. In some implementations, aspects of the operations of 904 may be performed by an NE as described with reference to FIG. 7.

At 906, the method may include attempting to decode an uplink communication in the first subset of the one or more PUSCH resources in response to receiving the indication. The operations of 906 may be performed in accordance with examples as described herein. In some implementations, aspects of the operations of 906 may be performed by an NE as described with reference to FIG. 7.

At 908, the method may include transmitting a dynamic uplink grant to a UE. The operations of 908 may be performed in accordance with examples as described herein. In some implementations, aspects of the operations of 906 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive a configuration that indicates a set of physical uplink control channel (PUCCH) resources and a set of physical uplink shared channel (PUSCH) resources,
wherein the set of PUCCH resources is configured for use based at least in part on a condition;
select a first subset of one or more PUSCH resources of the set of PUSCH resources based at least in part on the condition;
transmit an indication of the selected first subset of one or more PUSCH resources in at least one PUCCH resource of the set of PUCCH resources; and
transmit an uplink communication in the selected first subset of one or more PUSCH resources.

2. The UE of claim 1, wherein the one or more processors are further individually or collectively configured to cause the UE to:
receive a physical downlink control channel (PDCCH) transmission,
wherein the PDCCH transmission is associated with a cell-ratio network temporary identifier (C-RNTI) or a UE-triggered configured grant (UCG)-RNTI.

3. The UE of claim 2, wherein the received PDCCH transmission includes a dynamic uplink grant, wherein the received PDCCH transmission is associated with the C-RNTI, and wherein the C-RNTI is indicative of the transmitted uplink communication being successfully decoded.

4. The UE of claim 2, wherein the received PDCCH transmission includes a dynamic uplink grant, wherein the received PDCCH transmission is associated with the UCG-RNTI, and wherein the UCG-RNTI is indicative of the transmitted uplink communication being unsuccessfully decoded.

5. The UE of claim 2, wherein the PDCCH transmission indicates an activation of a second subset of one or more PUSCH resources of the set of PUSCH resources.

6. The UE of claim 1, wherein the first subset of the one or more PUSCH resources is selected based at least in part on an absence of a PDCCH transmission in response to a previous uplink communication on at least one PUSCH resource of the set of PUSCH resources, and wherein the condition comprises the absence of the PDCCH transmission.

7. The UE of claim 1, wherein the configuration is a UE-triggered configured grant (UCG).

8. The UE of claim 1, wherein the condition comprises one or more of UE status reporting or UE assistance messages, and wherein the first subset of one or more PUSCH resources of the set of PUSCH resources is selected based at least in part on the one or more of the UE status reporting or the UE assistance messages.

9. The UE of claim 1, wherein the one or more processors are further individually or collectively configured to cause the UE to:
transmit an indication to deactivate one or more PUCCH resources of the set of PUCCH resources based at least in part on the condition,
wherein the condition comprises an absence of uplink data available for a future uplink communication, one or more UE status reports, or one or more UE assistance messages.

10. The UE of claim 9, wherein the one or more processors are individually or collectively configured to cause the UE to:
jointly transmit the uplink communication and the indication to deactivate the one or more PUCCH resources in the selected first subset of one or more PUSCH resources.

11. The UE of claim 9, wherein the one or more processors are individually or collectively configured to cause the UE to:
transmit the indication to deactivate the one or more PUCCH resources in a second PUCCH resource different than the at least one PUCCH resource associated with the transmitted indication of the selected first subset of one or more PUSCH resources.

12. The UE of claim 1, wherein a time gap between an ending symbol of the at least one PUCCH resource and a starting symbol of the selected first subset of one or more PUSCH resources satisfies a threshold value.

13. The UE of claim 1, wherein a periodicity associated with the set of PUCCH resources is different than a periodicity associated with the set of PUSCH resources.

14. A network entity for wireless communication, comprising:
one or more memories; and
one or more processors coupled with the one or more memories and individually or collectively configured to cause the network entity to:
transmit a configuration that indicates a set of physical uplink control channel (PUCCH) resources and a set of physical uplink shared channel (PUSCH) resources,
wherein the set of PUCCH resources is configured for use based at least in part on a condition;
receive an indication of a selected first subset of one or more PUSCH resources of the set of PUSCH resources in at least one PUCCH resource of the set of PUCCH resources;
attempt to decode an uplink communication in the first subset of the one or more PUSCH resources in response to receiving the indication; and
transmit a dynamic uplink grant to a user equipment (UE).

15. The network entity of claim 14, wherein the one or more processors are individually or collectively configured to cause the network entity to transmit an indication to activate a second subset of the one or more PUSCH resources of the set of PUSCH resources in response to successfully decoding the uplink communication.

16. The network entity of claim 14, wherein the one or more processors are individually or collectively configured to cause the network entity to transmit a physical downlink control channel (PDCCH) transmission associated with a cell-ratio network temporary identifier (C-RNTI) or a UE-triggered configured grant (UCG)-RNTI for the UE.

17. The network entity of claim 16, wherein the PDCCH transmission includes the dynamic uplink grant and wherein the C-RNTI is indicative of the uplink communication being successfully decoded.

18. The network entity of claim 16, wherein the PDCCH transmission includes the dynamic uplink grant and wherein the UCG-RNTI is indicative of the uplink communication being unsuccessfully decoded.

19. A method performed by a user equipment (UE), the method comprising:
receiving a configuration that indicates a set of physical uplink control channel (PUCCH) resources and a set of physical uplink shared channel (PUSCH) resources,
wherein the set of PUCCH resources is configured for use based at least in part on a condition;
selecting a first subset of one or more PUSCH resources of the set of PUSCH resources based at least in part on the condition;
transmitting an indication of the selected first subset of one or more PUSCH resources in at least one PUCCH resource of the set of PUCCH resources; and
transmitting an uplink communication in the selected first subset of one or more PUSCH resources.

20. A method performed by a network entity, the method comprising:
transmitting a configuration that indicates a set of physical uplink control channel (PUCCH) resources and a set of physical uplink shared channel (PUSCH) resources,
wherein the set of PUCCH resources is configured for use based at least in part on a condition;
receiving an indication of a selected first subset of one or more PUSCH resources in at least one PUCCH resource of the set of PUCCH resources;
attempting to decode an uplink communication in the first subset of the one or more PUSCH resources in response to receiving the indication; and
transmitting a dynamic uplink grant to a user equipment (UE).
